(19) United States
(12) Patent Application Publication
(10) Pub. No.: US 2026/0185182 A1
(43) Pub. Date: Jul. 2, 2026

(54) PH MONITORING AND CONTROL FOR COPRECIPITATION OF CATHODE MATERIAL PRECURSORS

(71) Applicant: Ascend Elements, Inc., Westborough, MA (US)

(72) Inventor: Michael Pelsozy, Westborough, MA (US)

(21) Appl. No.: 19/432,280

(22) Filed: Dec. 24, 2025

Related U.S. Application Data
(60) Provisional application No. 63/740,223, filed on Dec. 30, 2024.
(60) Provisional application No. 63/852,761, filed on Jul. 29, 2025.

(51) Int. Cl. C22B 3/08; C22B 3/00; C22B 7/00; C22B 47/00; H01M 10/54

(52) U.S. Cl. CPC C22B 3/08; C22B 7/007; C22B 23/043; C22B 47/00; H01M 10/54

(57) ABSTRACT

A recycling process for Lithium-ion (Li-ion) batteries employs a closely monitored co-precipitation reaction for precipitating cathode active material precursor (pCAM) in a comingled form of metal salts corresponding to the intended chemistry for the new battery. The coprecipitation relies on a controlled pH that assures a particle size, morphology and purity of the resulting precipitated pCAM. A combination of internal reactor pH sensing within the coprecipitation reactor along with external pH sensing to validate the sensed pH ensures a consistent target pH throughout the coprecipitation process, compensating for drift or sensor failure in view of the harsh reactor environment.

### RELATED APPLICATIONS

This patent application claims the benefit under 35 U.S.C. § 119(e) of U.S. Provisional Patent App. No. 63/740,223 filed Dec. 30, 2024, entitled “PH MONITORING FOR COPRECIPITATION,” and of U.S. Provisional Patent App. No. 63/852,761, filed Jul. 29, 2025, entitled “PH MONITORING AND CONTROL FOR COPRECIPITATION OF CATHODE MATERIAL PRECURSORS,” both incorporated herein by reference in entirety.

### BACKGROUND

Lithium-ion (Li-ion) batteries are a preferred chemistry for secondary (rechargeable) batteries in high discharge applications such as electrical vehicles (EVs) and power tools where electric motors are called upon for rapid acceleration. Li-ion batteries include a charge material, conductive powder and binder applied to or deposited on a current collector, typically a planar sheet of copper or aluminum. The charge material includes anode material, typically graphite or carbon, and cathode material, which includes a predetermined ratio of metals such as lithium, nickel, manganese, cobalt, aluminum, iron and phosphorous, defining a so-called “battery chemistry” of the Li-ion cells. The preferred battery chemistry varies between vendors and applications, and recycling efforts of Li-ion batteries typically adhere to a prescribed molar ratio of the battery chemistry in recycled charge material products. Properties of the constituent products are closely monitored for aspects such as particle size, surface morphology, and purity, as these are highly relevant to electrical characteristics and performance of the recycled battery cells.

### SUMMARY

A recycling process for Lithium-ion (Li-ion) batteries employs a closely monitored coprecipitation reaction for forming a precursor cathode active material (pCAM) as a comingled form of metal salts corresponding to the intended chemistry for the new battery. Li-ion batteries rely on a precise combination of the metals in a predetermined ratio. The coprecipitation reaction occurs with a leach solution of dissolved metal salts at the predetermined ratio, generating pCAM as a granular material.

Coprecipitation relies on a controlled pH that assures a particle size, morphology and purity of the resulting precipitated pCAM. However, monitoring and maintaining a constant and reliable pH is challenging, particularly in the harsh reactive environment required for pCAM synthesis. A pH monitoring approach including a combination of internal reactor pH sensing from the coprecipitation reactor, along with external pH sensing, which validates a pH value for ensuring a correct pH in the coprecipitation reactor in view of possible sensory drift or sensor failure in view of the harsh reactor environment.

Thus, configurations herein are based, in part, on the observation that Li-ion battery recycling operations, and particularly the generation of pCAM for new batteries, relies on precisely controlled chemical processes to assure formation of pCAM having consistent targeted properties. Unfortunately, conventional approaches to pCAM generation suffer from the shortcoming that the harsh recycling environment presented by strong acids and caustic bases can adversely affect the process equipment, most notably pH sensors which are typically relied on to regulate the coprecipitation reaction of the pCAM product. Accordingly, configurations herein substantially overcome the shortcomings of conventional approaches by providing a multi-pronged pH validation and analytic testing approach that correlates internal and external pH measurements using statistical process control to ensure accuracy and validity of the required coprecipitation pH and for accommodating deviations in the automated process controls governing the reactor pH. This pH monitoring approach includes a combination of internal pH measurements of the coprecipitation within a reactor along with external pH measurements to validate the internal pH value, thereby ensuring that a target pH is maintained throughout the coprecipitation reaction, in view of possible sensory drift or sensor failure from the harsh reactor environment.

In further detail, configurations herein present a method for monitoring and controlling pH during a coprecipitation reaction forming cathode active material precursors, particularly from exhausted or scrap Li-ion batteries. The method comprises combining a base, a complexing agent, and an aqueous acidic leach solution of metal salts from recycled lithium-ion batteries to form a mixture comprising a coprecipitate of the metal salts in a reactor vessel at a target pH. A signal indicative of a sensed pH of the mixture in the reactor vessel is received, such as by a controller, and validates that the sensed pH is accurate based on an external pH test of the mixture using a statistical process control (SPC). Control of the pH continues by, if the validation confirms accuracy of the sensed pH, adding one or more of the base, the complexing agent, and the aqueous acidic leach solution of metal salts to coprecipitate an additional mixture of the metal salts at the target pH, and if the validation determines an inaccuracy between the sensed pH and the target pH, adjusting the addition of one or more of the base, the complexing agent, and the aqueous acidic solution of metal salts. The result is coprecipitation of a granular mixture of the metal salts at the target pH, thereby generating the pCAM.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a context diagram of a recycling environment suitable for use with configurations herein;

FIG. 2 is a schematic diagram of coprecipitation control in the environment of FIG. 1; and

FIG. 3 shows a schematic view of particle precipitation and growth into the coprecipitated granular solids in the containment reactor of FIG. 2.

### DETAILED DESCRIPTION

Depicted below is an example of pH control in a coprecipitation phase of a Li-ion battery recycling operation using Ni, Mn, Co (NMC) battery chemistry as an example, although the disclosed approach for statistical process control of coprecipitation pH is applicable to any suitable recycling process.

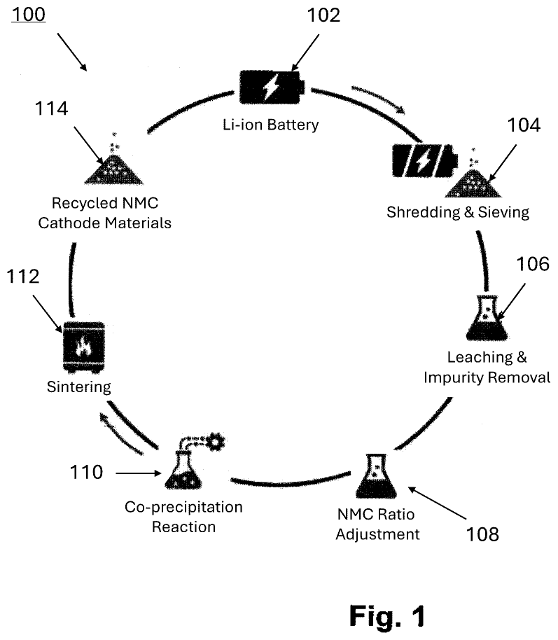

FIG. 1 is a context diagram of a recycling environment suitable for use with configurations herein. Referring to FIG. 1, a recycling scenario 100 begins with deployed Li-ion battery 102, typically from an EV. Li-ion batteries have a finite number of charge cycles before the ability of the charge material to accept sufficient charge degrades substantially. Add to this the batteries from premature end-of-life due to vehicle failure, collision damage, etc. The collective end-of-life recycling stream contributes to an abundant supply of exhausted batteries comprising spent cells and charge material. The batteries are discharged and agitated into a granular form 104, often referred to as a “black mass” through physical grinding, shredding and pulverizing. A leach process receives the black mass including the charge material and any incidental casing and current collectors of copper and aluminum. The black mass, including both cathode material of cathode material metal salts and anode materials of carbon and graphite, and an acidic aqueous leach solution are combined to form leach solution 106 including dissolved charge material metal salts.

The leach solution is then separated from the graphite rich precipitate. At this stage, the leach solution includes charge material metal salts based on the acid of the aqueous leach solution (such as sulfate salts of Ni, Mn and Co when the acid is sulfuric acid), however other charge material metals and/or leach acid may be employed. Leach solution 106 has a molar ratio of the charge material metals based on the constituent composition of the incoming recycling stream. The molar ratio can be adjusted with additional metal salts, typically from a virgin or control source, to yield target ratio-adjusted solution 108.

Coprecipitation reaction 110 occurs by adjusting the pH of the ratio-adjusted solution. As the pH increases, precipitation of the charge material metals (charge materials) occurs in the desired/targeted ratio resulting from the adjustment, discussed further below. An aqueous solution of base, such as sodium hydroxide or another strong base, can be used to increase the pH and cause the charge material metals to fall out of solution in a granular form, separable by filtration, typically as hydroxides. This comingled, granular form coprecipitated from the pH adjustment of the leach solution is the cathode material precursor, or pCAM, having the desired molar ratio for a target battery chemistry for new, recycled batteries. Sintering 112 in a furnace with a source of lithium, such as lithium carbonate or other lithium salts, forms cathode active material 114 (CAM) for the recycled Li-ion battery. In an example configuration, cathode active material, LiNiₓMn_{y}Co_{z}O₂ is synthesized by sintering NiₓMn_{y}Co_{z}(OH)₂ and Li₂CO₃, where x, y and z represent the respective molar ratios of Ni, Mn and Co. Common chemistries include NMC 111 (having an equal molar amounts of Ni, Mn and Co), NMC 811, NMC 622 and NMC 532, however any suitable molar ratio may be achieved by the process shown in FIG. 1. The recycled cathode material may then be merged back into the recycling stream as cathode material for the recycled battery.

In more specific detail, coprecipitation step 110 may generally be facilitated by combining an aqueous acidic leach solution of metal salts, (such as an aqueous mixed metal sulfate leach solution, MSO_{4(aq.)}), an aqueous base solution (such as an aqueous sodium hydroxide solution, NaOH_{(aq.)}), and an aqueous complexing agent solution (such as an aqueous ammonia solution, NH_{3(aq.)}). The combination may be simultaneous and may occur under an inert nitrogen atmosphere. In general, it is believed that the following chemical reactions are occurring simultaneously: the coprecipitation of the M(OH)₂ with sodium sulfate (Na₂SO₄) forming as a by-product (Eq. 1) and the complexation of metal cations (M²⁺) by NH₃ (Eq. 2), for which particularly Ni²⁺ exhibits a high affinity. Further, it is suggested that the coprecipitation of M(OH)₂ might also occur from the metal ammonia complex.

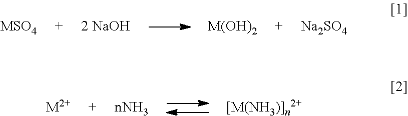

The above approach may thereby produce a coprecipitate having low particle sizes (such as from 4-16 μm) that are composed of numerous plate-like primary particles in the submicron range. After calcination at high temperatures, not only is the secondary particle structure of the pCAM preserved and reflected in the CAM structure, but also the electrochemical performance of the CAM in the LiB is significantly affected by the morphology of the associated pCAM that was used for the CAM synthesis. In general, therefore, coprecipitation is an acid-base neutralization process occurring in the presence of a complexing agent, as shown in equations 1 and 2 above, and relies on accurate pH control for generating a high performance pCAM product.

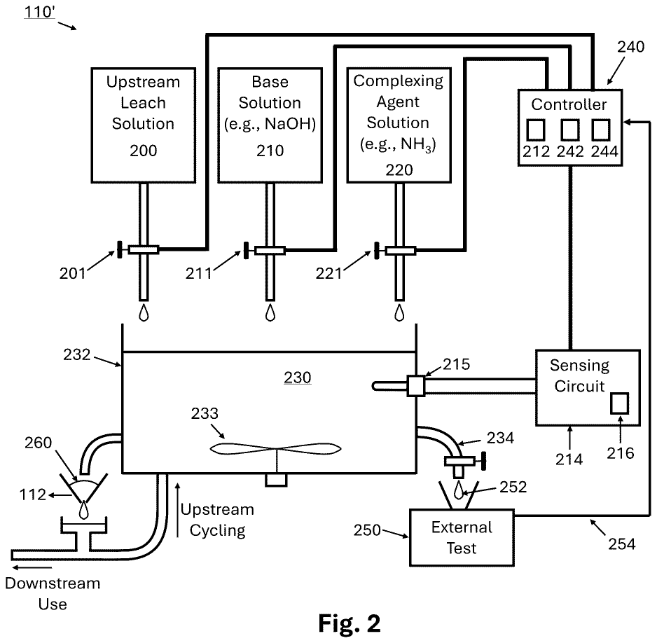

FIG. 2 is a schematic diagram of a coprecipitation reactor system useful in the environment of FIG. 1. Referring to FIGS. 1 and 2, when scaling recycling scenario 100 for viable production, the upstream leach 106 and ratio adjustment 108 may be formed from a black mass from a lithium-ion recycling stream. The black mass is formed from a shredded and sieved comingling of cathode and anode materials. In a particular configuration, employing an NMC chemistry, the cathode materials may include Ni, Mn and Co, of which at least 50 wt %, such as at least 80 wt %, of the cathode materials are Ni (a so-called “nickel rich” formulation). An aqueous acidic leach solution is formed from a leach agent and a recycling stream of Li-ion batteries to form the upstream leach 108. In a particular configuration, the upstream leach 108 may be formed from a process as described in U.S. Pat. No. 9,834,827, issued Dec. 5, 2017, entitled “Method and Apparatus For Recycling Lithium-Ion Batteries,” incorporated herein by reference in entirety. The leach agent is typically sulfuric acid, such that the cathode materials form metal sulfate salts with the sulfuric acid.

Coprecipitation 110 of the metal salts of the ratio-adjusted leach solution may be performed either as a continuous or batch process in which controlled amounts of an upstream leach solution resulting from leaching 106 and ratio adjustment 108, a base solution, and an optional complexing agent solution combine for coprecipitation. In a specific example of a production mode, the method for monitoring and controlling pH during a coprecipitation reaction includes combining an aqueous base solution, an aqueous complexing agent solution, and an upstream aqueous acidic leach solution of metal salts from recycled lithium-ion batteries in a reactor vessel to form a mixture including a coprecipitate of the metal salts at a target pH.

In more detail, as shown in FIG. 2, reactor system 110′ for generating recycled cathode material precursor (pCAM) for a Li-ion battery includes reactor vessel 232, configured for containment of mixture 230, and pH sensor 215 in communication with reactor vessel 232 for sensing the pH of mixture 230. Controller 240 maintains or adjusts coprecipitation conditions by pumping or otherwise providing a flow of upstream leach solution 200, base solution 210, and/or complexing agent solution 220 into the containment vessel based on sensed pH 216, often facilitated by mixer 233, baffle or similar agitation device. As shown, upstream aqueous acidic leach solution 200, base solution 210, and complexing agent solution 220 may have controlled fluidic communication with reactor vessel 232. For example, controller 240 may actuate any of control valves 201, 211 or 221 for adjusting the flow of the corresponding solution into reaction vessel 232.

In reactor system 110′, sensing circuit 214 receives a signal from pH sensor 215 indicative of sensed pH 216 of mixture 230 in reactor vessel 232. The sensed pH is generally computed by sensing circuit 214 based on the electrical signal from sensor 215 immersed in the mixture, such as through a sealed orifice in a side of vessel 232, immersed from above, or other suitable engagements for a physical contact with the liquid in vessel 232. Controller 240 receives the sensed pH for comparison with target pH 212, according to coprecipitation logic 242 of the controller.

Typically, if the controller determines that the sensed pH is within a pre-established range of the target pH, the addition of the aqueous acidic leach solution, aqueous complexing agent solution, and/or aqueous base solution continues without any change in rates or amounts. However, if the sensed pH of mixture 230 is determined to not be within the pre-established range of the target pH, changes to the addition of one or more of the components can be made by the controller to bring the sensed pH back with range. For example, base solution 210 may generally be added to raise the pH of and leach solution 200 may be generally added for reducing the pH. The pH of mixture 230 may vary between 2.0 to 11.0 depending on the coprecipitation logic 242.

However, the coprecipitation process in which an acidic aqueous leach solution, a base solution (such an aqueous hydroxide solution), and a complexing agent solution (such as an aqueous ammonia solution) are combined produces a very harsh environment for pH sensor 215, particularly sensitive glass pH sensors. For example, the target pH may be greater than 6, such as greater than 7. In particular, the target pH may be between about 8 and 12. This environment is known to quickly degrade the performance of the sensors and to age and end the life of the pH probes, often times during production. Failure of the pH sensor can compromise a production run by pH probe fouling, erroneous measurements, and from the switching of pH probes that were believed to be inaccurate. This leads to inconsistent production runs and produces product having varying quality, properties, and overall performance.

In order to assess, determine, and/or validate that the sensed pH determined by the pH sensor is accurate and that the pH sensor is in good working condition, the present method and reactor system includes an external pH test. In particular, one or more samples of mixture 230 are removed from the reactor and separately tested to determine the mixture pH. The testing may be automated or manual. For example, as shown in FIG. 2, reactor vessel 232 may include fluid access portal 234, which allows retrieval of samples 252 of mixture 230 for external pH test 250. One or multiple external pH tests may be run.

External pH test 250 determines whether sensed pH 216 is accurate and whether the pH sensor has become compromised. Measurement of the external pH may be performed by any suitable manner, such as confirmatory sensors, addition of reagents and result evaluations, litmus samples, or other suitable reading. For example, independent pH probes may be used that have not been subjected to the harsh reactor conditions. If external pH test 250 confirms the accuracy of sensed pH 216, then the pH sensor is in good condition and, if appropriate, controller 240 adds or continues to add one or more of base solution 210, complexing agent solution 220, and upstream aqueous acidic leach solution 200 of metal salts to coprecipitate an additional mixture of the metal salts at target pH 212. If, however, external pH test 250 determines that sensed pH 216 is not accurate, this would indicate a potential issue with the reliability of the pH sensor. Coprecipitation is therefore temporarily discontinued by ending the addition of the base solution, the complexing agent solution, and the aqueous acidic leach solution of metal salts. In this way, production of inconsistent product can be quickly stopped and avoided, and steps can be taken to remedy the inaccuracy, such as by checking the condition of the pH sensor and, if necessary, removing and replacing the pH sensor with a new pH sensor.

Once in place, the new pH sensor can be used to redetermine a sensed pH 216 to be compared to target pH 212. If the redetermined sensed pH is within the pre-established range of the target pH, the addition of the aqueous base solution, the aqueous complexing agent solution, and the aqueous acidic leach solution of metal salts into the reactor vessel can be continued to form additional mixture comprising the coprecipitate of the metal salts. If, however, the redetermined sensed pH is not within the pre-established range of the target pH, an adjustment can be made to the addition of one or more of the aqueous base solution, the aqueous complexing agent solution, and/or the aqueous acidic solution of metal salts into the reactor vessel, as may be determined by controller 240, to adjust the redetermined sensed pH to be within the pre-established range of the target pH, thereby forming additional mixture comprising the coprecipitate of the metal salts at the target pH. Adjustment may include an increase or decrease of any of the base 210, the complexing agent 220, and/or the aqueous acidic solution 200 to compensate for a determined shift or inaccuracy in the sensed pH 216 used by the coprecipitation logic 242.

Thus, the external pH test provides one or more external pH measurements that can be used to more accurately assess the pH of a coprecipitation process for preparing a consistent cathode active material precursor, particularly at large scale. This process may be done in concert with an SPC to correlate the sensed pH and the target pH. This combination can be used by controller 240 to execute proportional-integral-derivative (PID) control of reagents, and ultimately pH control of the process running in vessel 232. For example, the external pH test may compute the accuracy of sensed pH 216 based on the plurality of validating pH values, using a feedback channel 254 to the coprecipitation logic 242 for any needed adjustment. The coprecipitation logic 242 therefore controls the pH based on a statistical process control applied to the plurality of validated pH values and either sensed pH 216 or adjusted pH 244, and modifying the amounts added by the controller 240 accordingly.

The statistical process control can be any suitable combinatorial analysis of the multiple pH values, such as an average, mean, analytical trending, discarding of outliers, standard deviation, or a combination and/or time weighted tracking of any of the gathered pH values. It may involve an automated electronic sensing, visual analysis, or other suitable chemical-based testing or evaluation. In practice, a sampling of between 2 and 5 control readings may be determined, compared, and optionally augmented through mathematical, statistical, and/or intuitive observation.

The coprecipitation reaction generally follows an elevation of pH, as the leach solution is an acidic aqueous solution having a low pH. Upon introduction of the aqueous base solution (typically having a strong base such as sodium hydroxide), the Ni, Mn and Co sulfate salts coprecipitate out of solution and form filterable solid 260. The coprecipitated solids return to process 100 for sintering at 112. The filtrate may be returned to containment 230 or be passed to further downstream processes, depending on a batch or continuous nature of the process.

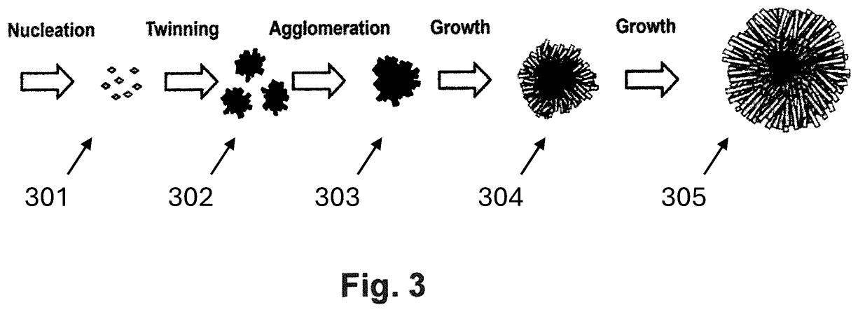

As described above, coprecipitation logic 242 controls the process pH for directing a “growth” of coprecipitated particles. FIG. 3 shows a schematic view of particle precipitation and growth into the coprecipitated granular solids 260, generally as a two-step secondary particle formation mechanism during coprecipitation of Ni, Mn, Co comingled hydroxides. While not wishing to be bound by any particularly theory, it is believed that, initially, nucleation 301 induces the formation of nanosized spheres comprised of several twinned plate-like primary particles 302 that are subjected to rapid and chaotic aggregation to undefined particle clusters 303. Due to solid bridge formation by ensuing lateral crystal growth of individual primary particles, the generated loose aggregates are consolidated into agglomerates, while primary particle growth in direction away of the agglomerate core results in radial extensions leading to aspherical secondary particles 304. Continuous secondary particle growth by polycrystallization, which is characterized by the lateral crystal growth of individual primary particles leads to a smearing out of the initial irregular agglomerate structure, so that eventually well-defined spherical secondary particles with a core-shell structure 305 are attained. FIG. 3 depicts one possible progression; various properties and performance related attributes of the precipitated solids 260 may be affected by the pH regulated by the coprecipitation logic 242.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for monitoring or controlling pH during a coprecipitation reaction forming a cathode active material precursor, comprising:
adding an aqueous base solution, an aqueous complexing agent solution, and an aqueous acidic leach solution of metal salts from recycled lithium-ion batteries into a reactor vessel to form a mixture comprising a coprecipitate of the metal salts at a target pH;
determining a sensed pH of the mixture in the reactor vessel using one or more pH sensors; and
determining the accuracy of the sensed pH using one or more external pH tests of the mixture.

2. The method of claim 1 wherein,
a) if the sensed pH is within a pre-established range of the target pH and
b) if the external pH test confirms accuracy of the sensed pH,
the method further comprises continuing to add the aqueous base solution, the aqueous complexing agent solution, and the aqueous acidic leach solution of metal salts into the reactor vessel to form additional mixture comprising the coprecipitate of the metal salts at the target pH.

3. The method of claim 1, wherein
a) if the sensed pH is within a pre-established range of the target pH and
b) if the external pH test determines an inaccuracy of the sensed pH,
the method further comprises discontinuing the addition of the aqueous base solution, the aqueous complexing agent solution, and the aqueous acidic leach solution of metal salts into the reactor vessel and evaluating the condition of the pH sensor.

4. The method of claim 3, further comprising
removing and replacing the pH sensor based on the evaluation, and redetermining the sensed pH, wherein
i) if the redetermined sensed pH is within the pre-established range of the target pH, the method further comprises continuing to add the aqueous base solution, the aqueous complexing agent solution, and the aqueous acidic leach solution of metal salts into the reactor vessel to form additional mixture comprising the coprecipitate of the metal salts at the target pH, or
ii) if the redetermined sensed pH is not within the pre-established range of the target pH, the method further comprises adjusting the addition of one or more of the aqueous base solution, the aqueous complexing agent solution, and the aqueous acidic solution of metal salts into the reactor vessel to adjust the redetermined sensed pH to be within the pre-established range of the target pH to form additional mixture comprising the coprecipitate of the metal salts at the target pH.

5. The method of claim 1, wherein
a) if the sensed pH is not within a pre-established range of the target pH and
b) if the external pH test confirms accuracy of the sensed pH,
the method further comprises adjusting the addition of one or more of the aqueous base solution, the aqueous complexing agent solution, and the aqueous acidic solution of metal salts into the reactor vessel to adjust the sensed pH to be within the pre-established range of the target pH to form additional mixture comprising the coprecipitate of the metal salts at the target pH.

6. The method of claim 5, wherein the method comprises adjusting the addition of the aqueous base solution.

7. The method of claim 1, wherein
a) if the sensed pH is not within a pre-established range of the target pH and
b) if the external pH test determines an inaccuracy of the sensed pH,
the method further comprises discontinuing the addition of the aqueous base solution, the aqueous complexing agent solution, and the aqueous acidic leach solution of metal salts into the reactor vessel and evaluating the condition of the pH sensor.

8. The method of claim 7, further comprising
removing and replacing the pH sensor based on the evaluation, and redetermining the sensed pH, wherein
i) if the redetermined sensed pH is within the pre-established range of the target pH, the method further comprises continuing to add the aqueous base solution, the aqueous complexing agent solution, and the aqueous acidic leach solution of metal salts into the reactor vessel to form additional mixture comprising the coprecipitate of the metal salts at the target pH, or
ii) if the redetermined sensed pH is not within the pre-established range of the target pH, the method further comprises adjusting the addition of one or more of the aqueous base solution, the aqueous complexing agent solution, and the aqueous acidic solution of metal salts into the reactor vessel to adjust the redetermined sensed pH to be within the pre-established range of the target pH to form additional mixture comprising the coprecipitate of the metal salts at the target pH.

9. The method of claim 1, wherein the one or more pH sensors are immersed in the mixture.

10. The method of claim 1, wherein the target pH is greater than 7.

11. The method of claim 10, wherein the target pH is from 8 to 11.

12. The method of claim 1, wherein the one or more external pH tests are performed by removing one or more samples of the mixture from the reactor vessel and measuring one or more pH values of the one or more samples.

13. The method of claim 12, wherein from 3 to 5 samples are removed from the reactor vessel.

14. The method of claim 1, wherein the aqueous acidic leach solution is prepared by combining a leach agent and a black mass comprising a crushed granular comingling of cathode and anode materials from the recycled lithium-ion batteries.

15. The method of claim 14, wherein the cathode material comprises Ni, Mn and Co and at least 50 mole % Ni.

16. The method of claim 15, wherein the cathode material at least 80% wt Ni.

17. The method of claim 14 wherein the leach agent is sulfuric acid and the cathode materials are metal sulfate salts.

18. The method of claim 1 wherein the base is sodium hydroxide.

19. The method of claim 1, wherein the complexing agent is ammonia.

20. A reactor system for generating cathode active material precursor for a recycled lithium-ion battery by a coprecipitation reaction, comprising:
a reactor vessel configured for forming and containing a mixture comprising a coprecipitate of metal salts at a target pH,
a container configured to feed an aqueous base solution into the reactor vessel,
a container configured to feed an aqueous complexing agent solution into the reactor,
a container configured to feed an aqueous acidic leach solution of the metal salts into the reactor,
a pH sensor in communication with the reactor vessel for determining a sensed pH of the mixture;
a controller for comparing the sensed pH and the target pH and maintaining coprecipitation conditions based on the sensed pH; and
one or more external pH tests to determine the accuracy of the sensed pH.
